(19) United States
(12) Patent Application Publication
(10) Pub. No.: US 2012/0139905 A1
(43) Pub. Date: Jun. 7, 2012

(54) Stereoscopic image display device and driving method thereof

(76) Inventor: Young-In Hwang, Yongin-City (KR)

(21) Appl. No.: 13/200,375

(22) Filed: Sep. 23, 2011

(30) Foreign Application Priority Data
Dec. 2, 2010 (KR) 10-2010-0122208

(51) Int. Cl. G06T 15/00

(52) U.S. Cl. 345/419

(57) ABSTRACT

A stereoscopic image display device may include: a display including a plurality of pixels; a data driver for applying first viewpoint image data and second viewpoint image data to a plurality of data lines connected to the pixels; a scan driver for applying a scan signal to a plurality of scan lines connected to the pixels to sequentially input the first viewpoint image data and the second viewpoint image data to the pixels; and a light emission driver for sequentially applying a light emitting signal to a plurality of light emitting lines connected to the pixels to allow the pixels to which the first viewpoint image data are input to sequentially emit light, and simultaneously applying a light emitting signal to a plurality of light emitting lines connected to the pixels to allow the pixels to which the second viewpoint image data are input to simultaneously emit light.

### RELATED APPLICATION

This application claims priority to and the benefit of Korean Patent Application No. 10-2010-0122208 filed in the Korean Intellectual Property Office on Dec. 2, 2010, the entire contents of which are incorporated herein by reference.

### BACKGROUND

1. Field

Embodiments relate to a stereoscopic image display device and a driving method thereof. More particularly, embodiments relate to a stereoscopic image display device for reducing driving speed of a data driving device and increasing luminance.

2. Description of the Related Art

A stereoscopic image display device realizes a 3D stereoscopic effect from a 2D image by using binocular disparity. In binocular disparity, the disparity of both eyes is increased if an observer is close to an object. Disparity of both eyes is decreased if the observer is far from the object. For example, if left and right images on a screen are adjusted to correspond to each other, the object is perceived to be disposed on the screen. However if the left-eye image is disposed on the left side and the right-eye image is disposed on the right side, the object is perceived to be disposed behind the screen. If the left-eye image is disposed on the right side and the right-eye image is disposed on the left side, the object is perceived to be disposed before the screen. Depth perception of the object disposed on the screen is determined by an interval between the right and left images.

The disclosed information in the Background is only for enhancing an understanding of the described technology. Therefore, it may contain information that does not form the prior art already known to a person of ordinary skill in the art in this country.

### SUMMARY

Embodiments may be directed to a stereoscopic image display device.

An exemplary embodiment may provide a stereoscopic image display device including: a display including a plurality of pixels; a data driver for applying first viewpoint image data and second viewpoint image data to a plurality of data lines connected to the plurality of pixels; a scan driver for applying a scan signal to a plurality of scan lines connected to the plurality of pixels to sequentially input the first viewpoint image data and the second viewpoint image data to the plurality of pixels; and a light emission driver for sequentially applying a light emitting signal to a plurality of light emitting lines connected to the plurality of pixels to allow the plurality of pixels to which the first viewpoint image data are input to sequentially emit light, and simultaneously applying a light emitting signal to the plurality of light emitting lines to allow the plurality of pixels to which the second viewpoint image data are input to simultaneously emit light.

The first viewpoint image data and the second viewpoint image data may be image data for displaying a frame of a stereoscopic image.

The data driver may divide the first viewpoint image data and the second viewpoint image data with respect to time, and may apply them to the plurality of data lines.

The stereoscopic image display device may further include an initialization driver for applying an initialization signal, the initialization driver initializing the first viewpoint image data or the second viewpoint image data input to the plurality of pixels, to a plurality of initialization lines connected to the plurality of pixels.

Each pixel of the plurality of pixels include: a driving transistor for transmitting a current, corresponding to the first viewpoint image data and the second viewpoint image data, to an organic light emitting diode (OLED); a first switching transistor for transmitting the first viewpoint image data and the second viewpoint image data to the driving transistor according to the scan signal; a second switching transistor for transmitting a first power source voltage to the driving transistor according to the first light emitting signal; a threshold voltage compensation transistor for initializing a gate voltage of the driving transistor and compensating a threshold voltage according to the initialization signal; and a light emitting transistor for transmitting a current flowing through the driving transistor to the organic light emitting diode (OLED) according to the second light emitting signal.

The first switching transistor may include: a gate electrode connected to a scan line; a first end connected to a data line; and a second end connected to a first end of the driving transistor.

The second switching transistor may include: a gate electrode connected to a first light emitting line; a first end connected to a first power source; and a second end connected to the first end of the driving transistor.

The threshold voltage compensation transistor may include: a gate electrode connected to an initialization line; a first end connected to a gate electrode of the driving transistor; and a second end connected to a second end of the driving transistor.

The light emitting transistor may include: a gate electrode connected to the second light emitting line; a first end connected to the second end of the driving transistor; and a second end connected to an anode of the organic light emitting diode (OLED).

Each pixel of the plurality of pixels may include a sustain capacitor for storing the gate voltage of the driving transistor.

The sustain capacitor may include: a first end connected to the first power source; and a second end connected to the gate electrode of the driving transistor.

Another embodiment may provide a method for driving a stereoscopic image display device including: inputting, sequentially, the first viewpoint image data to the plurality of pixels; displaying the first viewpoint image data by sequentially emitting the plurality of pixels; inputting, sequentially, the second viewpoint image data to the plurality of pixels; and displaying the second viewpoint image data by simultaneously emitting the plurality of pixels.

The first viewpoint image data and the second viewpoint image data may be image data for displaying a frame of a stereoscopic image.

Inputting, sequentially, the first viewpoint image data to the plurality of pixels may include: initializing a gate voltage of a driving transistor of each pixel of the plurality of pixels; and turning on the driving transistor by applying the gate voltage, generated by subtracting a threshold voltage of the driving transistor from the first viewpoint image data, to the gate electrode of the driving transistor.

Displaying the first viewpoint image may include controlling the organic light emitting diode (OLED) to emit light by transmitting a pixel current corresponding to the first viewpoint image data to the organic light emitting diode (OLED) through the turned on driving transistor.

Displaying the first viewpoint image may include displaying, sequentially, the first viewpoint image data by sequentially applying a light emitting signal of a gate-on voltage to the plurality of pixels disposed on the first scan line to the last scan line.

Inputting the second viewpoint image data may include: initializing a gate voltage of a driving transistor of each pixel; and turning on the driving transistor by applying the gate voltage, generated by subtracting a threshold voltage of the driving transistor from the second viewpoint image data, to the gate electrode of the driving transistor.

Displaying the second viewpoint image includes displaying, simultaneously, the second viewpoint image data by simultaneously applying a light emitting signal of a gate-on voltage to the plurality of pixels disposed on the first scan line to the last scan line.

The method may further include initializing the image data input to the plurality of pixels in a previous frame before the first viewpoint image data are input to the plurality of pixels.

Initializing the image data input to the plurality of pixels may include initializing the gate voltage of the driving transistor included in each pixel by simultaneously applying an initial voltage to the plurality of pixels.

The method may further include initializing the image data input to the plurality of pixels and inputting black data to the plurality of pixels.

Inputting black data to the plurality of pixels may include inputting, simultaneously, black data to the plurality of pixels by applying a scan signal of a gate-on voltage to the plurality of pixels.

Displaying the first viewpoint image data may include displaying black data before the first viewpoint image data is input, and after black data is input to the plurality of pixels.

### BRIEF DESCRIPTION OF THE DRAWINGS

FIG. 1 shows a block diagram of a stereoscopic image display device according to an exemplary embodiment.

FIG. 2 shows a driving operation of a stereoscopic image display device according to a left and right-eye images sequential light emitting scheme.

FIG. 3 shows a driving operation of a stereoscopic image display device according to a left and right-eye images sequential/simultaneous light emitting scheme according to an exemplary embodiment.

FIG. 4 shows a circuit diagram of a pixel according to an exemplary embodiment.

FIG. 5 shows a timing diagram of a method for driving a stereoscopic image display device according to an exemplary embodiment.

FIG. 6 shows a circuit diagram of a pixel according to another exemplary embodiment.

FIG. 7 shows a timing diagram of a method for driving a stereoscopic image display device according to another exemplary embodiment.

FIG. 8 shows a left and right-eye images sequential light emitting sheme to compare with a left and right-eye images sequential/simultaneous light emitting scheme according to an exemplary embodiment.

FIG. 9 shows a left and right-eye images sequential/simultaneous light emitting scheme to compare with a left and right-eye images sequential light emitting scheme according to an exemplary embodiment.

### DETAILED DESCRIPTION OF THE EMBODIMENTS

Korean Patent Application No. 10-2010-0122208, filed on Dec. 2, 2010, in the Korean Intellectual Property Office, and entitled “Stereoscopic Image Display Device and Driving Method Thereof,” is incorporated by reference herein in its entirety.

Present embodiments will not be described more fully hereinafter with reference to the accompanying drawings, in which exemplary embodiments of the inventive concept are illustrated. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

Constituent elements having the same structures throughout the embodiments are denoted by the same reference numerals and are described in a first embodiment. In the other embodiments, only constituent elements other than the same constituent elements will be described.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

The stereoscopic image display device can be realized as various flat panel displays such as a liquid crystal display (LCD), a field emission display (FED), a plasma display panel (PDP), and an organic light emitting diode (OLED) display. For better understanding and ease of description, the organic light emitting diode (OLED) display will now be exemplified, and the stereoscopic image display device according to an embodiment is not restricted thereto.

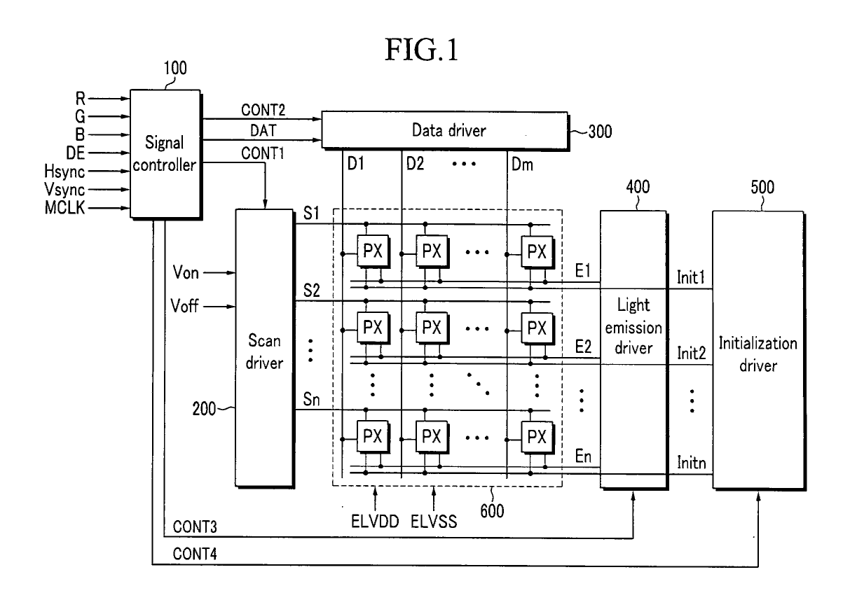

FIG. 1 shows a block diagram of a stereoscopic image display device according to an exemplary embodiment.

Referring to FIG. 1, the stereoscopic image display device includes a display 600, a scan driver 200 connected to the display 600, a data driver 300, a light emission driver 400, an initialization driver 500, and a signal controller 100 for controlling the respective drivers 200, 300, 400, and 500.

The signal controller 100 receives video signals (R, G, B) input by an external device and an input control signal for controlling display of the video signals. The video signals (R, G, B) have luminance information of the respective pixels (PX), and the luminance has a predetermined number of grays such as 1024=2¹⁰, 256=2⁸, or 64=2⁶. The input control signal includes a vertical synchronization signal (Vsync), a horizontal synchronization signal (Hsync), a main clock signal (MCLK), and a data enable signal (DE).

The signal controller 100 processes the input video signals (R, G, B) according to operational conditions of the display 600 and the data driver 300 by using the input video signals (R, G, B) and the input control signal, and generates a scan control signal (CONT1), a data control signal (CONT2), a light emission control signal (CONT3), an initialization control signal (CONT4), and an image data signal (DAT). The signal controller 100 transmits the scan control signal (CONT1) to the scan driver 200. The signal controller 100 transmits the data control signal (CONT2) and the image data signal (DAT) to the data driver 300. The image data signal (DAT) includes a left-eye image data signal and a right-eye image data signal. The signal controller 100 transmits the light emission control signal (CONT3) to the light emission driver 400. The signal controller 500 transmits the initialization control signal (CONT4) to the initialization driver 500.

The display 600 includes a plurality of scan lines S1-Sn, a plurality of data lines D1-Dm, a plurality of light emitting lines E1-En, a plurality of initialization lines Init1-Initn, and a plurality of pixels (PX) connected to the plurality of signal lines S1-Sn, D1-Dm, E1-En, Init1-Initn. The plurality of pixels (PX) may be arranged in a matrix form. The scan lines S1-Sn are extended substantially in the row direction and are substantially in parallel with each other, and the data lines D1-Dm are extended substantially in the column direction and are substantially in parallel with each other. The light emitting lines E1-En correspond to the scan lines S1-Sn and are extended substantially in the row direction. The initialization lines Init1-Initn correspond to the scan lines S1-Sn and are extended substantially in the row direction. The scan lines S1-Sn are connected to the scan driver 200, the data lines D1-Dm are connected to the data driver 300, the light emitting lines E1-En are connected to the light emission driver 400, and the initialization lines Init1-Initn are connected to the initialization driver 500. The pixels (PX) of the display 600 receive a first power source voltage (ELVDD) and a second power source voltage (ELVSS) from an external device.

The scan driver 200 is connected to the scan lines S1-Sn, and applies a scan signal that is generated by combining a gate-on voltage (Von) and a gate-off voltage (Voff) to the scan lines S1-Sn according to the scan control signal (CONT1). The scan driver 200 applies the scan signal to the scan lines S1-Sn so that the data signal may be applied to the pixels (PX). The scan driver 200 applies the scan signal to the scan lines S1-Sn so that first viewpoint image data and second viewpoint image data may be sequentially input to the pixels. The first viewpoint image data and the second viewpoint image data represent image data for displaying a frame of the stereoscopic image.

The data driver 300 is connected to the data lines D1-Dm, and selects a gray voltage according to an image data signal (DAT). The data driver 300 applies the gray voltage selected according to the data control signal (CONT2) to the data lines D1-Dm as a data signal. The data signal includes left-eye image data for displaying a left-eye image and right-eye image data for displaying a right-eye image. That is, the data driver 300 applies the first viewpoint image data and the second viewpoint image data to the data lines D1-Dm. The data driver 300 temporally identifies the first viewpoint image data and the second viewpoint image data and applies them to the data lines D1-Dm.

The light emission driver 400 is connected to the light emitting lines E1-En, and applies a light emitting signal that is a combination of the gate-on voltage and the gate-off voltage to the light emitting lines E1-En according to the light emission control signal (CONT3). The light emission driver 400 applies a light emitting signal to the light emitting lines E1-En, so that the pixel, in which the first viewpoint image data is input, may sequentially emit light. The pixel in which the second viewpoint image data is input, may simultaneously emit light.

The initialization driver 500 is connected to the initialization lines Init1-Initn, and applies an initialization signal that is a combination of the gate-on voltage and the gate-off voltage to the initialization lines Init1-Initn according to the initialization control signal CONT4. The initialization driver 500 applies an initialization signal for initializing the first viewpoint image data or the second viewpoint image data that are input in advance to the pixels to the initialization lines Init1-Initn.

The driving devices 100, 200, 300, 400, and 500 can be installed on the display 600 as at least one integrated circuit chip, on the flexible printed circuit film, on the display 600 in a tape carrier package (TCP) form, or on an additional printed circuit board (PCB). The driving devices 100, 200, 300, 400, and 500 can be integrated into the display 600 together with the signal lines S1-Sn, D1-Dm, and Init1-Initn.

A driving operation of a time-division stereoscopic image display device will now be described.

A single frame represents a unit for distinguishing the images displayed on the stereoscopic image display device. To display the stereoscopic image, the left-eye image and the right-eye image must be displayed by temporal or spatial division.

In the exemplary embodiment, the left-eye image and the right-eye image are temporally distinguished to display the stereoscopic image. The method for displaying the stereoscopic image by temporally distinguishing the left-eye image and the right-eye image is called a time-division method. One frame of the stereoscopic image in the time-division method indicates a unit image of the stereoscopic image by which the left-eye image and the right-eye image are temporally divided and displayed on the screen. The corresponding left-eye image and the right-eye image in one frame are recognized as a stereoscopic image by the viewer.

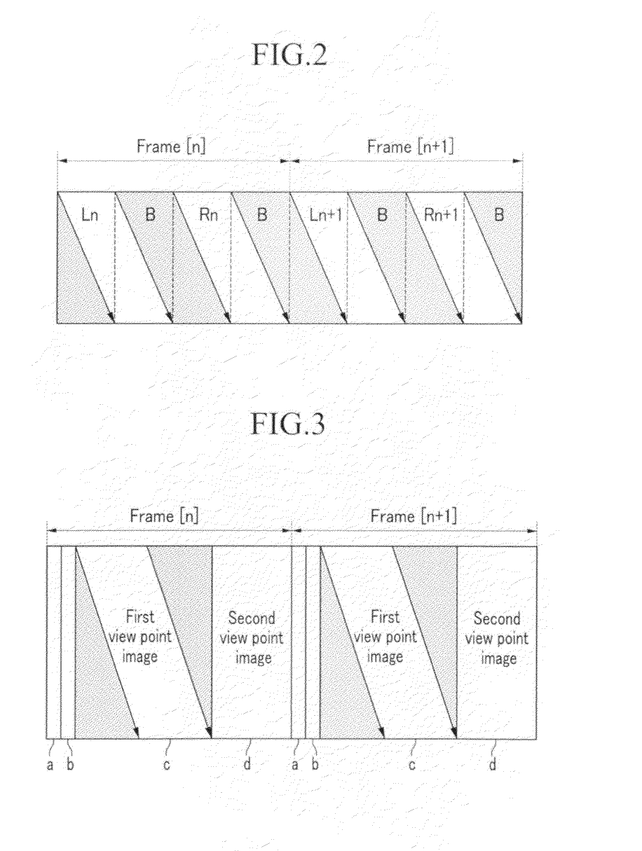

FIG. 2 shows a driving operation of a stereoscopic image display device according to a left and right-eye images sequential light emitting scheme.

Referring to FIG. 2, a method for a time-divisional stereoscopic image display device, using shutter spectacles to display left and right images, includes a left and right-eye sequential light emitting scheme. The left and right-eye images sequential light emitting scheme sequentially inputs left-eye image data to the pixels to sequentially emit the pixels and sequentially inputs right-eye image data to the pixels to sequentially emit the pixels. Black data for dividing the right and left images are input to the pixels, between the left-eye image data and the right-eye image data, and between the right-eye image data and the left-eye image data. The black data are input to prevent the reduction of the stereoscopic effect because the left-eye image is displayed to the right eye or the right-eye image is displayed to the left eye.

For example, as shown, in the n-th frame (Frame[n]), the left-eye image data (Ln) is sequentially input to the pixels, and the pixels sequentially emit light. While the pixels sequentially emit light, the black data (B) are input to the pixels. When the black data (B) are input and are not overlapped on the left-eye image data (Ln), the right-eye image data (Rn) are sequentially input to the pixels, and the pixels sequentially emit light. While the pixels sequentially emit light, the black data (B) are input to the pixels. That is, in the n-th frame, the left-eye image data (Ln), the black data (B), the right-eye image data (Rn), and the black data (B) are sequentially input to the pixels. In the (n+1)-th frame (Frame[n+1]), the left-eye image data (Ln+1), the black data (B), the right-eye image data (Rn+1), and the black data (B) are input to the pixels in a like order of the n-th frame.

According to the left and right-eye images sequential light emitting scheme, image data for the first viewpoint and image data for the second viewpoint are sequentially input in the entire frames. The pixels in which the image data for the first viewpoint or the image data for the second viewpoint are input, sequentially emit light.

The first viewpoint indicates one of the left eye viewpoint and the right eye viewpoint. The second viewpoint indicates one of the first viewpoint and another one. The image for the first viewpoint will be called a first viewpoint image, and the image for the second viewpoint will be called a second viewpoint image. The data for the first viewpoint image will be called a first viewpoint image data, and the data for the second viewpoint image will be called a second viewpoint image data.

According to the left and right-eye images sequential light emitting scheme, data are input four times in the order of the first viewpoint image data, the black data, the second viewpoint image data, and the black data in one frame for displaying a single stereoscopic image. The stereoscopic image display device must input data to the pixels four times faster than the driving speed of the 2D display device. For example, the stereoscopic image display device must display the image that is displayed at 60 Hz by the 2D display device at 240 Hz. The stereoscopic image display device reduces the luminance of the image to ½ because of insertion of the black data compared to the 2D display device. To supplement this, the stereoscopic image display device must output the image with doubled luminance, so the power consumption amount is increased.

FIG. 3 shows a driving operation of a stereoscopic image display device according to a left and right-eye images sequential/simultaneous light emitting scheme according to an exemplary embodiment.

Referring to FIG. 3, the left and right image display method, by the time-divisional stereoscopic image display device using shutter spectacles, includes a left and right-eye images sequential/simultaneous light emitting scheme. The left and right-eye images sequential/simultaneous light emitting scheme alternately displays the corresponding first viewpoint image and the second viewpoint image, and displays the first viewpoint image according to the sequential light emitting scheme and the second viewpoint image according to the simultaneous light emitting scheme.

The left and right-eye images sequential/simultaneous light emitting scheme includes (a) initializing entire pixels, (b) inputting black data to the entire pixels, (c) sequentially emitting light, and (d) simultaneously emitting light.

The (a) initializing of the entire pixels includes initializing the image data input of the pixels in the previous frame. In other words, initializing a gate voltage at the driving transistor included in the pixels.

The (b) inputting of black data to the entire pixels includes inputting black data to the entire pixels in order to control other pixels to be in the black state when the pixels sequentially emit light in the sequential light emitting stage.

The (c) sequentially emitting of light includes sequentially emitting the pixels by sequentially inputting the first viewpoint image data to the pixels. In this instance, the second viewpoint image data are sequentially input to the pixels after the first viewpoint image data are sequentially input to the pixels.

The (d) simultaneous emitting of light includes simultaneously emitting the pixels to which the second viewpoint image data are input.

According to the left and right-eye images sequential/simultaneous light emitting scheme, the first viewpoint image data and the second viewpoint image data are sequentially input to the pixels, the pixels to which the first viewpoint image data are input, sequentially emit light, and the pixels to which the second viewpoint image data are input, simultaneously emit light.

The (c) sequentially inputs the image data and emits the pixels for the respective scan lines, and (a), (b), and (d) are performed for the entire pixels.

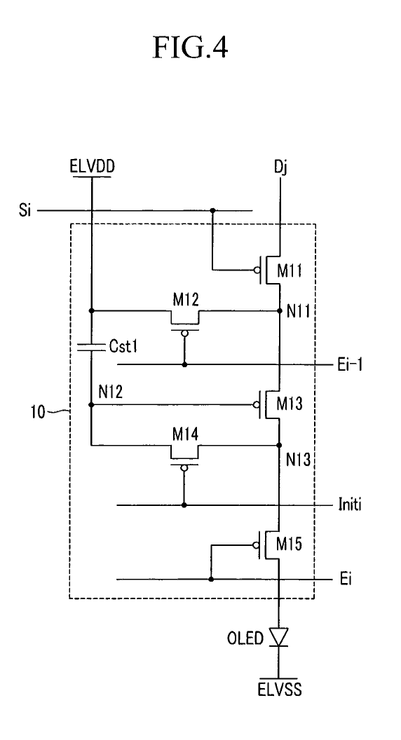

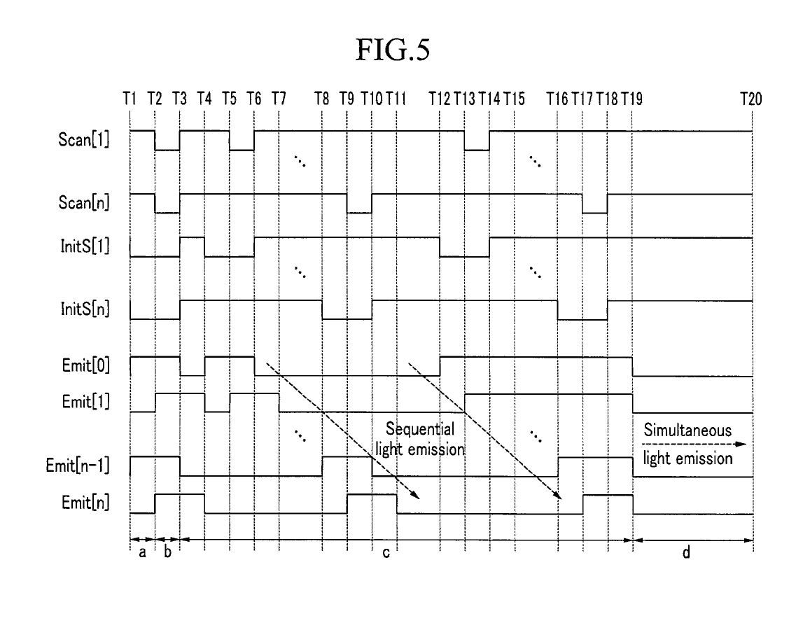

FIG. 4 shows a circuit diagram of a pixel according to an exemplary embodiment.

Referring to FIG. 4, the pixel (PX) included in the stereoscopic image display device for performing the left and right-eye images sequential/simultaneous light emitting scheme includes an organic light emitting diode (OLED) and a pixel circuit 10 for controlling the organic light emitting diode (OLED).

The pixel circuit 10 includes a first switching transistor M11, a second switching transistor M12, a driving transistor M13, a threshold voltage compensation transistor M14, a light emitting transistor M15, and a sustain capacitor Cst1.

The first switching transistor M11 includes a gate electrode connected to the scan line (Si), a first end connected to the data line (Dj), and a second end connected to the first node N11. The first switching transistor M11 controls the data signal to be transmitted to the driving transistor M13 according to the scan signal. The data signal includes the first viewpoint image data and the second viewpoint image data.

The second switching transistor M12 includes a gate electrode connected to a first light emitting line Ei−1, a first end connected to a first power source voltage (ELVDD), and a second end connected to the first node N11. The first light emitting line Ei−1 signifies a light emitting line connected to a plurality of pixels dispose on the previous scan line Si−1. The second switching transistor M12 controls the first power source voltage (ELVDD) to be transmitted to the driving transistor M13 according to the first light emitting signal.

The driving transistor M13 includes a gate electrode connected to a second node N12, a first end connected to a first node N11, and a second end connected to a third node N13. The driving transistor M13 controls the current corresponding to the data signal to be transmitted to the organic light emitting diode (OLED).

The threshold voltage compensation transistor M14 includes a gate electrode connected to an initialization line (Initi), a first end connected to the second node N12, and a second end connected to the third node N13. The threshold voltage compensation transistor M14 initializes the gate voltage of the driving transistor M13 according to the initialization signal. The threshold voltage compensation transistor M14 is diode-connected to the driving transistor M13 to compensate for a threshold voltage of the driving transistor M13.

The light emitting transistor M15 includes a gate electrode connected to the second light emitting line (Ei), a first end connected to the third node N13, and a second end connected to an anode of the organic light emitting diode (OLED). The second light emitting line (Ei) represents a light emitting line connected to a plurality of pixels disposed on the scan line (Si). The light emitting transistor M15 controls the current that flows through the driving transistor M13 to be transmitted to the organic light emitting diode (OLED) according to the second light emitting signal.

The sustain capacitor Cst1 includes a first end connected to the first power source voltage (ELVDD) and a second end connected to the second node N12. The sustain capacitor Cst1 stores the gate voltage of the driving transistor M13.

The first node N11 is connected to the second end of the first switching transistor M11, the second end of the second switching transistor M12, and the first end of the driving transistor M13. The second node N12 is connected to the gate electrode of the driving transistor M13, the first end of the threshold voltage compensation transistor M14, and the second end of the sustain capacitor Cst1. The third node N13 is connected to the second end of the driving transistor M13, the second end of the threshold voltage compensation transistor M14, and the first end of the light emitting transistor M15.

The organic light emitting diode (OLED) includes an anode connected to the second end of the light emitting transistor M15 and a cathode connected to the second power source voltage (ELVSS).

The first switching transistor M11, the second switching transistor M12, the driving transistor M13, the threshold voltage compensation transistor M14, and the light emitting transistor M15 can be p-channel field effect transistors. In this instance, the gate-on voltage for turning on the first switching transistor M11, the second switching transistor M12, the driving transistor M13, the threshold voltage compensation transistor M14, and the light emitting transistor M15 is a logic low level voltage, and the gate-off voltage for turning them off is a logic high level voltage.

The p-channel field effect transistors are shown, and at least one of the first switching transistor M11, the second switching transistor M12, the driving transistor M13, the threshold voltage compensation transistor M14, and the light emitting transistor M15 can be an n-channel field effect transistor. In that case, the gate-on voltage for turning on the n-channel field effect transistor is a logic high level voltage and the gate-off voltage for turning it off is a logic low level voltage.

The organic light emitting diode (OLED) emits light of one of primary colors. An example of the primary colors can be red, green, and blue. The desired color is expressed by spatial or temporal sum of the three primary colors. In this case, some of the organic light emitting diode (OLED) can emit white light and thereby increase luminance. The organic light emitting diode (OLED) of all the pixels (PX) can emit white light, and some of the pixels (PX) can further include a color filter (not shown) for changing the white light output by the organic light emitting diode (OLED) into one of the primary colors.

FIG. 5 shows a timing diagram of a method for driving a stereoscopic image display device according to an exemplary embodiment.

FIG. 5 shows a method for driving the stereoscopic image display device including the pixels of FIG. 4 according to the left and right-eye images sequential/simultaneous light emitting scheme.

The Scan[1] represents a scan signal applied to the gate electrode of the first switching transistor M11 of the pixel disposed on the first scan line, and the Scan[n] represent a scan signal applied to the gate electrode of the first switching transistor M11 of the pixel disposed to the n-th scan line.

The InitS[1] represents an initialization signal (InitS) applied to the gate electrode of the threshold voltage compensation transistor M14 of the pixel disposed on the first scan line, and the InitS[n] represents an initialization signal (InitS) applied to the gate electrode of the threshold voltage compensation transistor M14 of the pixel disposed on the n-th scan line.

The Emit[0] represents a light emitting signal (Emit) applied to the gate electrode of the second switching transistor of the pixel disposed on the first scan line, and the Emit[1] represents a light emitting signal (Emit) applied to the gate electrode of the light emitting transistor of the pixel disposed on first scan line. The Emit[1] is applied to the gate electrode of the second switching transistor of the pixel disposed on the second scan line. The Emit[n−1] represents a light emitting signal (Emit) applied to the gate electrode of the second switching transistor of the pixel disposed on the n-th scan line, and the Emit[n] represents a light emitting signal (Emit) applied to the gate electrode of the light emitting transistor M15 of the pixel disposed on the n-th line. The Emit[n−1] is applied to the gate electrode of the light emitting transistor of the pixel disposed on the (n−1)-th scan line.

In (a) initializing of the entire pixels, the scan driver 200 applies a scan signal (Scan) as the gate-off voltage to the scan lines S1-Sn according to the scan control signal (CONT1) transmitted by the signal controller 100. The initialization driver 500 applies an initialization signal (InitS) as the gate-on voltage to the initialization lines (Init1-Initn) according to the initialization control signal (CONT4) transmitted by the signal controller 100. The light emission driver 400 applies a light emitting signal (Emit) as the gate-off voltage to the gate electrode of the second switching transistor M12 and a light emitting signal (Emit) as the gate-on voltage to the light emitting transistor M15 according to the light emission control signal (CONT3) transmitted by the signal controller 100. To achieve this, the light emission driver 400 can include a light emitting drive unit for blocking the light emitting signal (Emit) as the gate-on voltage from the gate electrode of the second switching transistor M12 and applying the light emitting signal as the gate-off voltage while applying the light emitting signal (Emit) as the gate-on voltage to the light emitting lines (E1-En). The light emitting drive unit can apply an additional signal to the gate electrode of the second switching transistor M12 or the gate electrode of the light emitting transistor M15 when the light emitting signal applied to the gate electrode of the second switching transistor M12 needs to be different from the light emitting signal applied to the gate electrode of the light emitting transistor M15.

In (a), the first switching transistor M11 and the second switching transistor M12 are turned off, and the threshold voltage compensation transistor M14 and the light emitting transistor M15 are turned on. Accordingly, the first power source voltage (ELVDD) is applied to the first end of the sustain capacitor Cst1 and the second power source voltage (ELVSS) is applied to the second end thereof so the voltage stored in the sustain capacitor Cst1, i.e., the voltage applied to the gate electrode of the driving transistor M13, is initialized.

In (b), the scan driver 200 applies the scan signal (Scan) as the gate-on voltage to the scan lines S1-Sn. The initialization driver 500 applies the initialization signal (initS) as the gate-on voltage to the initialization lines (Init1-Initn). The light emission driver 400 applies the light emitting signal (Emit) as the gate-off voltage to the light emitting lines (E1-En). In this instance, the data driver 300 applies black data to the data lines D1-Dm. The black data indicates a data voltage for generating the lowest level of luminance in the organic light emitting diode (OLED).

In (b), the second switching transistor M12 and the light emitting transistor M15 are turned off, and the first switching transistor M11 and the threshold voltage compensation transistor M14 are turned on. Accordingly, the gate electrode of the driving transistor M13 is connected to the first end of the threshold voltage compensation transistor M14, and the second end of the driving transistor M13 is connected to the second end of the threshold voltage compensation transistor M14 so the driving transistor M13 is diode-connected. The black data applied to the data line (Dj) is transmitted to the gate electrode of the driving transistor M13 through the threshold voltage compensation transistor M14, and the gate voltage of the driving transistor M13, i.e., the voltage corresponding to the black data, is stored in the sustain capacitor Cst1. Black data is simultaneously input to the pixels.

The (c) includes intervals T3 to T19 during which the first viewpoint image data are sequentially input to the pixels to sequentially emit the pixels, the first viewpoint image data are input to the pixels, and the second viewpoint image data are then sequentially input to the pixels.

First, a stage for inputting the first viewpoint image data to the pixels disposed on the first scan line and emitting light in (c) will be described.

In the intervals T4 and T5, the scan signal (Scan[1]) is applied as the gate-off voltage, the initialization signal (InitS[1]) as the gate-on voltage, the first light emitting signal (Emit[0]) as the gate-off voltage, and the second light emitting signal (Emit[1]) as the gate-on voltage. The first switching transistor M11 and the second switching transistor M12 are turned off, and the threshold voltage compensation transistor M14 and the light emitting transistor M15 are turned on. The first power source voltage (ELVDD) is applied to the first end of the sustain capacitor Cst1 and the second power source voltage (ELVSS) is applied to the second end so the voltage stored in the sustain capacitor Cst1, i.e., the gate voltage applied to the gate electrode of the driving transistor M13, is initialized.

In the intervals T5 and T6, the scan signal (Scan[1]) is applied as the gate-on voltage, the initialization signal (InitS[1]) as the gate-on voltage, the first light emitting signal (Emit[0]) as the gate-off voltage, and the second light emitting signal (Emit[1]) as the gate-off voltage. In this instance, the data driver 300 applies the first viewpoint image data to the data lines D1-Dm. The second switching transistor M12 and the light emitting transistor M15 are turned off, and the first switching transistor M11 and the threshold voltage compensation transistor M14 are turned on. The gate electrode of the driving transistor M13 is connected to the first end of the threshold voltage compensation transistor M14 and the second end of the driving transistor M13 is connected to the second end of the threshold voltage compensation transistor M14 so the driving transistor M13 is diode-connected. The first viewpoint image data applied to the data line (Dj) is transmitted to the gate electrode of the driving transistor M13 through the threshold voltage compensation transistor M14. Since the driving transistor M13 is diode-connected, the gate voltage (Vdat-Vth) generated by subtracting the threshold voltage (Vth) of the driving transistor M13 from the voltage (Vdat) of the first viewpoint image data is applied to the gate electrode of the driving transistor M13. The gate voltage (Vdat−Vth) is stored in the sustain capacitor Cst1.

In the intervals T6 and T7, the scan signal (Scan[1]) is applied as the gate-off voltage, the initialization signal (InitS[1]) as the gate-off voltage, the first light emitting signal (Emit[0]) as the gate-on voltage, and the second light emitting signal (Emit[1]) as the gate-off voltage. Therefore, the first switching transistor M12, the threshold voltage compensation transistor M14, and the light emitting transistor M15 are turned off, and the second switching transistor M12 is turned on. The driving transistor M13 maintains the turned-on state by the gate voltage stored in the sustain capacitor Cst1, and the first power source voltage (ELVDD) is transmitted to the driving transistor M13 through the second switching transistor M12.

In the intervals T7 to T12, the scan signal (Scan[1]) is applied to the gate-off voltage, the initialization signal (InitS[1]) to the gate-off voltage, the first light emitting signal (Emit[0]) to the gate-on voltage, and the second light emitting signal (Emit[1]) to the gate-on voltage. Accordingly, the first switching transistor M12 and the threshold voltage compensation transistor M14 are turned off, and the second switching transistor M12 and the light emitting transistor M15 are turned on. The first power source voltage (ELVDD) is transmitted to the driving transistor M13 through the second switching transistor M12, and the driving transistor M13 transmits a pixel current corresponding to the gate voltage (Vdat−Vth), i.e., the voltage (Vdat) of the first viewpoint image data, to the organic light emitting diode (OLED). The organic light emitting diode (OLED) emits light with predetermined luminance according to the pixel current.

Similar to the described stage in which the first viewpoint image data are input to the pixels disposed on the first scan line and the pixels emit light, the first viewpoint image data are sequentially input to the pixels disposed after the first scan line and the pixels emit light. In this instance, the pixels disposed after the first scan line display the black data until the first viewpoint image data are input after (a) and (b).

A stage for inputting the first viewpoint image data to the pixels disposed after the first scan line and emitting light in (c) will now be described. For ease of description, a stage for inputting the first viewpoint image data to the pixels disposed on the n-th scan line and emitting light will be described.

In the intervals T3 and T4, the scan signal (Scan[n]) is applied as the gate-off voltage, the initialization signal (InitS[n]) as the gate-off voltage, the first light emitting signal (Emit[n−1]) applied to the first light emitting line (En−1) as the gate-on voltage, and the second light emitting signal (Emit[n]) applied to the second light emitting line (En) as the gate-off voltage. Accordingly, the first switching transistor M12, the threshold voltage compensation transistor M14, and the light emitting transistor M15 are turned off, and the second switching transistor M12 is turned on. The driving transistor M13 maintains the turned-on state by the black data stored in the sustain capacitor Cst1, and the first power source voltage (ELVDD) is transmitted to the driving transistor M13 through the second switching transistor M12.

In the intervals T4 to T8, the scan signal (Scan[n]) is applied as the gate-off voltage, the initialization signal (InitS[n]) as the gate-off voltage, the first light emitting signal (Emit[n−1]) applied to the first light emitting line (En−1) as the gate-on voltage, and the second light emitting signal (Emit[n]) applied to the second light emitting line (En) as the gate-on voltage. Accordingly, the first switching transistor M12 and the threshold voltage compensation transistor M14 are turned off, and the second switching transistor M12 and the light emitting transistor M15 are turned on. The first power source voltage (ELVDD) is transmitted to the driving transistor M13 through the second switching transistor M12, and the driving transistor M13 transmits the pixel current corresponding to the black data to the organic light emitting diode (OLED). The pixels disposed on the n-th scan line start inputting the first viewpoint image data after T8. The pixels disposed on the n-th scan line display the black data until the first viewpoint image data are input after (a) and (b).

In the intervals T8 and T9, the voltage applied to the gate electrode of the driving transistor M13 of the pixels disposed on the n-th scan line is initialized.

In the intervals T9 and T10, the gate voltage (Vdat−Vth) is applied to the gate electrode of the driving transistor M13.

In the intervals T10 and T11, the driving transistor M13 maintains the turned-on state by the gate voltage stored in the sustain capacitor Cst1, and the first power source voltage (ELVDD) is transmitted to the driving transistor M13 through the second switching transistor M12.

In the intervals T11 to T16, the pixel current corresponding to the gate voltage (Vdat−Vth) of the driving transistor M13, i.e., the voltage (Vdat) of the first viewpoint image data, flows to the organic light emitting diode (OLED), and the organic light emitting diode (OLED) emits light with predetermined luminance following the pixel current.

The drive of the pixels disposed on the n-th scan line in the intervals T8 to T16 is performed in a like manner of the above-described drive of the pixels disposes on the first scan line in the intervals T4 to T12.

Accordingly, the first viewpoint image data are sequentially input by the scan signals as the gate-on voltage sequentially applied to the pixels from those disposed on the first scan line to those disposed on the n-th scan line. The first viewpoint image data are sequentially displayed by second light emitting signals as the gate-on voltage sequentially applied to the pixels from those disposed on the first scan line to those disposed on the n-th scan line.

A stage for inputting the second viewpoint image data to the pixels disposed on the first scan line and emitting light in the sequential light emitting stage (c) will now be described.

In the intervals T12 and T13, the process for initializing the voltage applied to the gate electrode of the driving transistor M13 of the pixels disposed on the first scan line is performed in a similar manner to the intervals T4 and T5.

In the intervals T13 and T14, the process for applying the gate voltage (Vdat−Vth) to the gate electrode of the driving transistor M13 of the pixels disposed on the first scan line is performed in a similar manner to the intervals T5 and T6.

In the intervals T14 to T19, the scan signal (Scan[1]), the initialization signal (InitS[1]), the first light emitting signal (Emit[0]), and the second light emitting signal (Emit[1]) are applied as the gate-off voltage. The gate voltage (Vdat-Vth) is maintained to be applied to the gate electrode of the driving transistor M13 until the time T19 when the input of the second viewpoint image data to the pixels is completed.

A stage for inputting the second viewpoint image data to the pixels disposed after the first scan line and emitting light in (c) will now be described. A stage for inputting the second viewpoint image data to the pixels disposed on the n-th scan line and emitting light will now be described.

In the intervals T16 and T17, the process for initializing the voltage applied to the gate electrode of the driving transistor M13 of the pixels disposed on the n-th scan line is performed in a similar manner to the intervals T8 and T9.

In the intervals T17 and T18, the process for applying the gate voltage (Vdat−Vth) to the gate electrode of the driving transistor M13 of the pixels disposed on the n-th scan line is performed in a similar manner to the intervals T9 and T10.

In the intervals T18 and T19, the scan signal (Scan[1]), the initialization signal (InitS[1]), the first light emitting signal (Emit[0]), and the second light emitting signal (Emit[1]) are applied as the gate-off voltage. The gate voltage (Vdat−Vth) is maintained to be applied to the gate electrode of the driving transistor M13 until the time T19 when the inputting of the second viewpoint image data to the pixels is completed.

Accordingly, after the time T11 when the inputting of the first viewpoint image data is finished, the second viewpoint image data are sequentially input by the scan signals as the gate-on voltage sequentially applied to the pixels disposed on the first scan line to the n-th scan line.

The (d) includes the intervals T19 and T20 in which the entire pixels simultaneously emit light. In the intervals T19 and T20, the scan signals (Scan[1]-[n]) and the initialization signals (InitS[1]-InitS[n]) are applied as the gate-off voltage, and the light emitting signals (Emit[0]-Emit[n]) are applied as the gate-on voltage. Accordingly, the first switching transistor M11 and the threshold voltage compensation transistor M14 of the respective pixels are turned off, and the second switching transistor M12 and the light emitting transistor M15 are turned on. The driving transistor M13 of each pixel transmits the pixel current corresponding to the second viewpoint image data stored in the sustain capacitor Cst1 to the organic light emitting diode (OLED). The organic light emitting diode (OLED) emits light of predetermined luminance following the pixel current.

The second viewpoint image data are simultaneously displayed by simultaneously applying the second light emitting signal as the gate-on voltage after the second viewpoint image data are input to the pixels disposed on the first scan line to the n-th scan line.

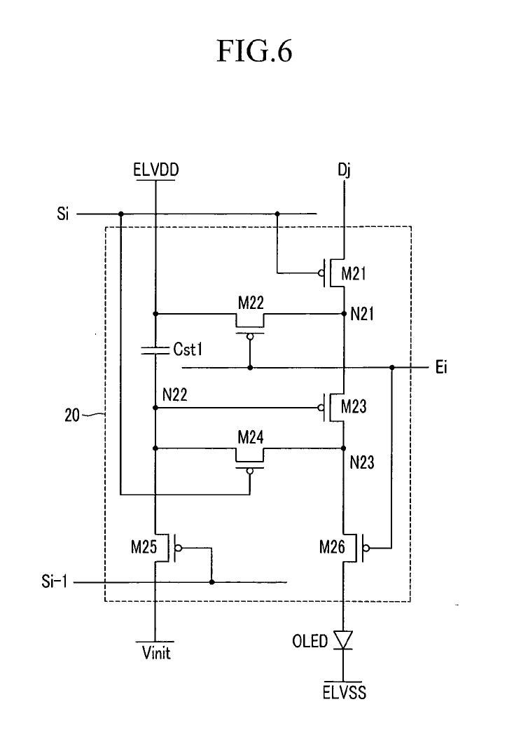

FIG. 6 shows a circuit diagram of a pixel according to another exemplary embodiment.

Referring to FIG. 6, the pixel (PX) realizes the left and right-eye images sequential/simultaneous light emitting scheme by using the scan signal (Scan) of the scan driver 200 and the light emitting signal (Emit) of the light emission driver 400, omitting the initialization driver 500 from the stereoscopic image display device of FIG. 1.

The pixel (PX) includes an organic light emitting diode (OLED) and a pixel circuit 20 for controlling the organic light emitting diode (OLED).

The pixel circuit 20 includes a first switching transistor M21, a second switching transistor M22, a driving transistor M23, a threshold voltage compensation transistor M24, an initialization transistor M25, a light emitting transistor M26, and a sustain capacitor Cst2.

The first switching transistor M21 includes a gate electrode connected to the scan line (Si), a first end connected to the data line (Dj), and a second end connected to the first node N21.

The second switching transistor M22 includes a gate electrode connected to the light emitting line (Ei), a first end connected to the first power source voltage (ELVDD), and a second end connected to the first node N21.

The driving transistor M23 includes a gate electrode connected to the second node N22, a first end connected to the first node N21, and a second end connected to the third node N23.

The threshold voltage compensation transistor M24 includes a gate electrode connected to the scan line (Si), a first end connected to the second node N22, and a second end connected to the third node N23.

The initialization transistor M25 includes a gate electrode connected to the scan line Si−1 of the previous line, a first end connected to the second node N22, and a second end connected to an initial voltage source (Vinit).

The light emitting transistor M26 includes a gate electrode connected to the light emitting line (Ei), a first end connected to the third node N23, and a second end connected to the anode of the organic light emitting diode (OLED).

The sustain capacitor Cst2 includes a first end connected to the first power source voltage (ELVDD) and a second end connected to the second node N22.

The first node N21 is connected to the second end of the first switching transistor M21, the second end of the second switching transistor M22, and the first end of the driving transistor M23. The second node N22 is connected to the gate electrode of the driving transistor M23, the first end of the threshold voltage compensation transistor M24, the first end of the initialization transistor M25, and the second end of the sustain capacitor Cst2. The third node N23 is connected to the second end of the driving transistor M23, the second end of the threshold voltage compensation transistor M24, and the first end of the light emitting transistor M26.

The organic light emitting diode (OLED) includes an anode connected to the second end of the light emitting transistor M26 and a cathode connected to the second power source voltage (ELVSS).

The first switching transistor M21, the second switching transistor M22, the driving transistor M23, the threshold voltage compensation transistor M24, the initialization transistor M25, and the light emitting transistor M26 can be p-channel field effect transistors. In this instance, the gate-on voltage for turning on the first switching transistor M21, the second switching transistor M22, the driving transistor M23, the threshold voltage compensation transistor M24, the initialization transistor M25, and the light emitting transistor M26 is a logic low level voltage, and the gate-off voltage for turning the same off is a logic high level voltage.

The p-channel field effect transistors are used, and at least one of the first switching transistor M21, the second switching transistor M22, the driving transistor M23, the threshold voltage compensation transistor M24, the initialization transistor M25, and the light emitting transistor M26 can be an n-channel field effect transistor. In this instance, the gate-on voltage for turning on the n-channel field effect transistor is the logic high level voltage and the gate-off voltage for turning it off is the logic low level voltage.

The organic light emitting diode (OLED) can emit one of primary colors. An example of the primary colors can be red, green, and blue. The desired color is expressed by a spatial or temporal sum of the three primary colors. In this case, some of the organic light emitting diode (OLED) can emit white light and increases luminance. The organic light emitting diode (OLED) of all the pixels (PX) can emit white light. Some of the pixels (PX) can further include a color filter (not shown) for changing the white light output by the organic light emitting diode (OLED) into one of the primary colors.

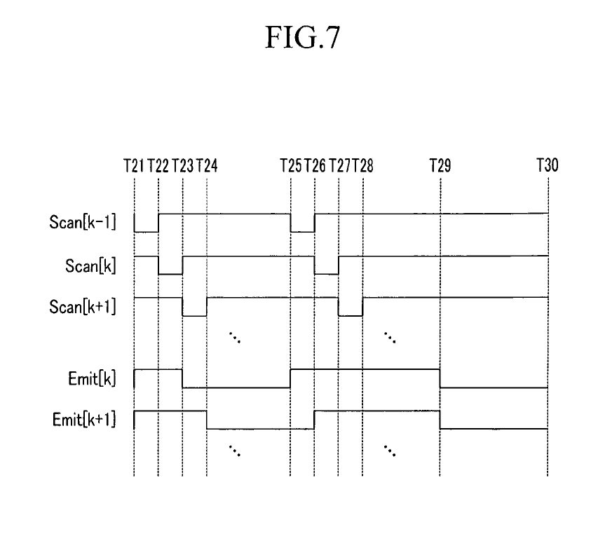

FIG. 7 shows a timing diagram of a method for driving a stereoscopic image display device according to another exemplary embodiment.

FIG. 7 shows a method for driving the stereoscopic image display device including the pixels of FIG. 6, according to the left and right eye images sequential/simultaneous light emitting scheme. Scan[k] signifies a scan signal (Scan) applied to the k-th scan line, and Emit[k] indicates a light emitting signal (Emit) applied to the k-th light emitting line.

For ease of description, the pixel connected to the k-th scan line will now be described.

In the intervals T21 and T22, the scan signal (Scan[k−1]) of the previous scan line is applied as the gate-on voltage, the scan signal (Scan[k]) of the corresponding scan line as the gate-off voltage, and the light emitting signal (Emit[k]) as the gate-off voltage. The first switching transistor M21, the second switching transistor M22, the threshold voltage compensation transistor M24, and the light emitting transistor M26 are turned off, and the initialization transistor M25 is turned on. Accordingly, the first power source voltage (ELVDD) is applied to the first end of the sustain capacitor Cst2, and a voltage of the initial voltage source (Vinit) to the second end. The data stored in the sustain capacitor Cst2, i.e., the gate voltage of the driving transistor M23, are initialized.

In the intervals T22 and T23, the scan signal (Scan[k−1]) of the previous scan line is applied as the gate-off voltage, the scan signal (Scan[k]) of the corresponding scan line as the gate-on voltage, and the light emitting signal (Emit[k]) as the gate-off voltage. In this instance, the data driver 300 applies the first viewpoint image data to the data lines D1-Dm. The second switching transistor M22, the initialization transistor M25, and the light emitting transistor M26 are turned off, and the first switching transistor M21 and the threshold voltage compensation transistor M24 are turned on. Accordingly, the gate electrode of the driving transistor M23 is connected to the first end of the threshold voltage compensation transistor M24, and the second end of the driving transistor M23 is connected to the second end of the threshold voltage compensation transistor M24 so the driving transistor M23 is diode-connected. Since the driving transistor M23 is diode-connected, the gate voltage (Vdat1−Vth) generated by subtracting the threshold voltage (Vth) of the driving transistor M23 from the voltage (Vdat1) of the first viewpoint image data is applied to the gate electrode of the driving transistor M23. The gate voltage (Vdat1−Vth) is stored in the sustain capacitor Cst2.

In the intervals T23 to T25, the scan signal (Scan[k−1]) of the previous scan line and the scan signal (Scan[k]) of the corresponding scan line are applied as the gate-off voltage, and the light emitting signal (Emit[k]) as the gate-on voltage. The first switching transistor M21, the threshold voltage compensation transistor M24, and the initialization transistor M25 are turned off, and the second switching transistor M22 and the light emitting transistor M26 are turned on. Accordingly, the first power source voltage (ELVDD) is transmitted to the driving transistor M23 through the second switching transistor M22, the driving transistor M23 transmits the pixel current corresponding to the gate voltage (Vdat1−Vth), i.e., the voltage (Vdat) of the first viewpoint image data, to the organic light emitting diode (OLED). The organic light emitting diode (OLED) emits light of predetermined luminance following the pixel current.

The pixel connected to the k-th scan line displays the first viewpoint image data from T23 to T25. At the time T25, the gate voltage stored in the sustain capacitor Cst2 is initialized so as to input the second viewpoint image data.

The pixel connected to the (k+1)-th scan line displays the first viewpoint image data from T24 to T26. The first viewpoint image data are sequentially input to the pixels, and the pixels sequentially emit light to display the first viewpoint image data.

In the intervals T25 and T26, the gate voltage of the driving transistor M23 stored in the sustain capacitor Cst2 is initialized in a like manner of the intervals T21 and T22.

In the intervals T26 to T27, the data driver 300 applies the second viewpoint image data to the data lines D1-Dm, and the gate voltage (Vdat2−Vth) generated by subtracting the threshold voltage (Vth) of the driving transistor M23 from the second viewpoint image data voltage (Vdat2) is applied to the gate electrode of the driving transistor M23 in a similar manner to the intervals T22 and T23. The gate voltage (Vdat2-Vth) is stored in the sustain capacitor Cst2.

In the intervals T27 to T29, the scan signal (Scan[k−1]) of the previous scan line, the scan signal (Scan[k]) of the corresponding scan line, and the light emitting signal (Emit[k]) are applied as the gate-off voltage. Accordingly, the gate voltage (Vdat2−Vth) stored in the sustain capacitor Cst2 is maintained during the intervals T27 to T29.

The gate voltage (Vdat2−Vth) corresponding to the second viewpoint image data in the intervals T27 and T28 is stored in the sustain capacitor Cst2 of the pixel connected to the (k+1)-th scan line, and the gate voltage (Vdat2−Vth) is maintained during the intervals T27 to T29.

The second viewpoint image data is sequentially applied to the pixels until the time T29, and is stored in the sustain capacitor Cst2 of each pixel as the gate voltage (Vdat2−Vth).

In the intervals T29 to T30, the light emitting signal (Emit) as the gate-on voltage, is simultaneously applied to the entire light emitting lines (E1-En). Accordingly, the light emitting transistors M26 of the pixels are turned on, and the organic light emitting diodes (OLED) of the pixels simultaneously emit light by the pixel current corresponding to the voltage (Vdat) of the second viewpoint image data.

The second viewpoint image data is sequentially input to the pixels. The entire pixels simultaneously emit light starting from the time T29 to display the second viewpoint image data.

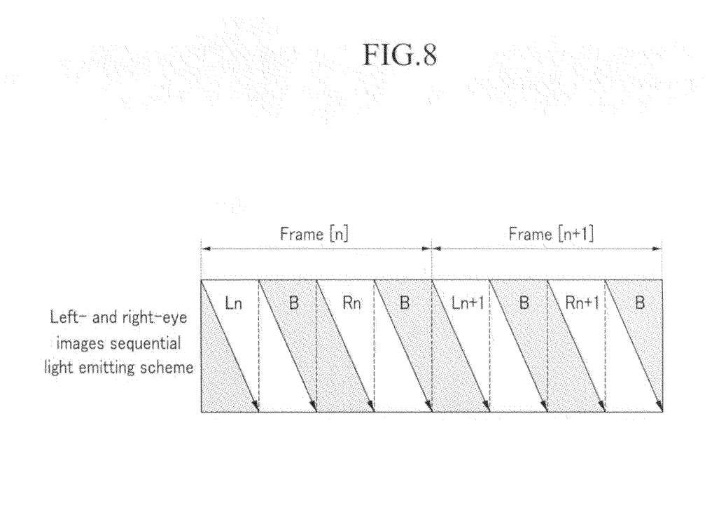

FIG. 8 shows a left and right-eye images sequential light emitting scheme to compare with a left and right-eye images sequential/simultaneous light emitting scheme according to an exemplary embodiment.

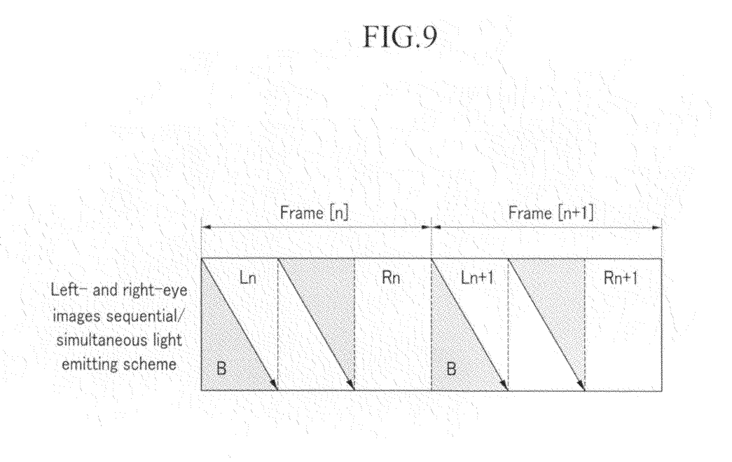

FIG. 9 shows a left and right-eye images sequential/simultaneous light emitting scheme to compare with a left and right-eye images sequential light emitting scheme according to an exemplary embodiment.

Referring to FIGS. 8 and 9, the stereoscopic image display device, driven by the left and right-eye images sequential light emitting scheme, inputs left-eye image data (Ln), right-eye image data (Rn), and two black data (B) to the pixels for one frame. However, the stereoscopic image display device, driven by the left and right-eye images sequential/simultaneous light emitting scheme, can reduce the inputting of the black data (B) once compared to the left and right-eye images sequential light emitting scheme.

Accordingly, the stereoscopic image display device driven by the left and right-eye images sequential/simultaneous light emitting scheme, can reduce the driving speed for inputting data to the pixels compared to the stereoscopic image display device driven by the left and right-eye images sequential light emitting scheme. For example, the image displayed in 60 Hz by the 2D display device is displayed at 240 Hz by the stereoscopic image display device driven by the left and right-eye images sequential light emitting scheme, and it can be displayed at 180 Hz by the stereoscopic image display device driven by the left and right-eye images sequential/simultaneous light emitting scheme.

The stereoscopic image display device, driven by the left and right-eye images sequential light emitting scheme, reduces the luminance by ½ since the interval in which the black data is displayed occupies half of one frame. On the other hand, the stereoscopic image display device driven by the left and right-eye images sequential/simultaneous light emitting scheme, reduces the luminance by ⅓, since the interval in which the black data is displayed occupies ⅓ of one frame. The stereoscopic image display device, driven by the left and right-eye images, sequential/simultaneous light emitting scheme can reduce the decrease of luminance compared to the stereoscopic image display device driven by the left and right-eye images sequential light emitting scheme. Since the luminance is reduced, the stereoscopic image display device driven by the left and right-eye images sequential/simultaneous light emitting scheme can reduce power consumption, since it can increase the output of the image that is to be increased. Thus, there is a supplement to the decrease of luminance, lesser than the stereoscopic image display device driven by the left and right-eye images sequential light emitting scheme.

A conventional method to display the stereoscopic image is a method of dividing and selecting a left-eye image and a right-eye image, displayed with a red color and a blue color, by color spectacles. The color spectacles use color filters having a relationship of complementary colors. The method in which the left-eye image and the right-eye images are displayed uses different polarization. The images are divided and selected by polarizing spectacles. The method using the color spectacles has a drawback. The object is not displayed with a natural color. The method using the polarizing spectacles has another drawback in that the left-eye image is recognized through the right eye or the right-eye image is recognized through the left eye according to polarization capacity. Thus, the stereoscopic effect is deteriorated.

Present embodiments may be directed to a stereoscopic image display device, capable of decreasing driving speed of a stereoscopic image display device of a time-division type using shutter spectacles and increasing luminance. Present embodiments may also include a driving method. According to present embodiments, the stereoscopic image display device of a time-division type using the shutter spectacles may decrease driving speed of data to display the inputted stereoscopic image, reduce luminance by black data, and may reduce power consumption.

Exemplary embodiments of present embodiments have been disclosed herein, and although specific terms are employed, they are to be used and to be interpreted in a generic and descriptive sense only and not for purpose of limitation. Accordingly, it will be understood by those of ordinary skill in the art that various changes in form and details may be made without departing from the spirit and scope of the inventive concept as set forth in the following claims.

What is claimed is:

1. A stereoscopic image display device, comprising:
a display including a plurality of pixels;
a data driver for applying first viewpoint image data and second viewpoint image data to a plurality of data lines connected to the plurality of pixels;
a scan driver for applying a scan signal to a plurality of scan lines connected to the plurality of pixels to sequentially input the first viewpoint image data and the second viewpoint image data to the plurality of pixels; and
a light emission driver for sequentially applying a light emitting signal to a plurality of light emitting lines connected to the plurality of pixels to allow the plurality of pixels to which the first viewpoint image data are input to sequentially emit light, and simultaneously applying a light emitting signal to the plurality of light emitting lines to allow the plurality of pixels to which the second viewpoint image data are input to simultaneously emit light.

2. The stereoscopic image display device as claimed in claim 1, wherein:
the first viewpoint image data and the second viewpoint image data are image data for displaying a frame of a stereoscopic image.

3. The stereoscopic image display device as claimed in claim 2, wherein:
the data driver divides the first viewpoint image data and the second viewpoint image data with respect to time, and
the data driver applies them to the plurality of data lines.

4. The stereoscopic image display device as claimed in claim 1, further comprising:
an initialization driver for applying an initialization signal, the initialization driver initializing the first viewpoint image data or the second viewpoint image data input to the plurality of pixels, to a plurality of initialization lines connected to the plurality of pixels.

5. The stereoscopic image display device as claimed in claim 4, each pixel of the plurality of pixels comprises:
a driving transistor for transmitting a current, corresponding to the first viewpoint image data and the second viewpoint image data, to an organic light emitting diode (OLED);
a first switching transistor for transmitting the first viewpoint image data and the second viewpoint image data to the driving transistor according to the scan signal;
a second switching transistor for transmitting a first power source voltage to the driving transistor according to the first light emitting signal;
a threshold voltage compensation transistor for initializing a gate voltage of the driving transistor and compensating a threshold voltage according to the initialization signal; and
a light emitting transistor for transmitting a current flowing through the driving transistor to the organic light emitting diode (OLED) according to the second light emitting signal.

6. The stereoscopic image display device as claimed in claim 5, the first switching transistor comprises:
a gate electrode connected to a scan line;
a first end connected to a data line; and
a second end connected to a first end of the driving transistor.

7. The stereoscopic image display device as claimed in claim 5, the second switching transistor comprises:
a gate electrode connected to a first light emitting line;
a first end connected to a first power source; and
a second end connected to the first end of the driving transistor.

8. The stereoscopic image display device as claimed in claim 5, the threshold voltage compensation transistor comprises:
a gate electrode connected to an initialization line;
a first end connected to a gate electrode of the driving transistor; and
a second end connected to a second end of the driving transistor.

9. The stereoscopic image display device as claimed in claim 5, the light emitting transistor comprises:
a gate electrode connected to the second light emitting line;
a first end connected to the second end of the driving transistor; and
a second end connected to an anode of the organic light emitting diode (OLED).

10. The stereoscopic image display device as claimed in claim 5, each pixel of the plurality of pixels comprises:
a sustain capacitor for storing the gate voltage of the driving transistor.

11. The stereoscopic image display device as claimed in claim 10, the sustain capacitor comprises:
a first end connected to the first power source; and
a second end connected to the gate electrode of the driving transistor.

12. A method for driving a stereoscopic image display device, the method comprising:
inputting, sequentially, the first viewpoint image data to the plurality of pixels;
displaying the first viewpoint image data by sequentially emitting the plurality of pixels;
inputting, sequentially, the second viewpoint image data to the plurality of pixels; and
displaying the second viewpoint image data by simultaneously emitting the plurality of pixels.

13. The method as claimed in claim 12, wherein:
the first viewpoint image data and the second viewpoint image data are image data for displaying a frame of a stereoscopic image.

14. The method as claimed in claim 12, inputting, sequentially, the first viewpoint image data to the plurality of pixels comprises:
initializing a gate voltage of a driving transistor of each pixel of the plurality of pixels; and
turning on the driving transistor by applying the gate voltage, generated by subtracting a threshold voltage of the driving transistor from the first viewpoint image data, to the gate electrode of the driving transistor.

15. The method as claimed in claim 14, displaying the first viewpoint image comprises:
controlling the organic light emitting diode (OLED) to emit light by transmitting a pixel current corresponding to the first viewpoint image data to the organic light emitting diode (OLED) through the turned on driving transistor.

16. The method as claimed in claim 12, displaying the first viewpoint image comprises:
displaying, sequentially, the first viewpoint image data by sequentially applying a light emitting signal of a gate-on voltage to the plurality of pixels disposed on the first scan line to the last scan line.

17. The method as claimed in claim 12, inputting the second viewpoint image data comprises:
initializing a gate voltage of a driving transistor of each pixel of the plurality of pixels; and
turning on the driving transistor by applying the gate voltage, generated by subtracting a threshold voltage of the driving transistor from the second viewpoint image data, to the gate electrode of the driving transistor.

18. The method as claimed in claim 12, displaying the second viewpoint image comprises:
displaying, simultaneously, the second viewpoint image data by simultaneously applying a light emitting signal of a gate-on voltage to the plurality of pixels disposed on the first scan line to the last scan line.

19. The method as claimed in claim 12, further comprising:
initializing the image data input to the plurality of pixels in a previous frame before the first viewpoint image data are input to the plurality of pixels.

20. The method as claimed in claim 19, initializing the image data input to the plurality of pixels comprises:
initializing the gate voltage of the driving transistor included in each pixel of the plurality of pixels by simultaneously applying an initial voltage to the plurality of pixels.

21. The method as claimed in claim 19, further comprising:
initializing the image data input to the plurality of pixels and inputting black data to the plurality of pixels.

22. The method as claimed in claim 21, inputting black data to the plurality of pixels comprises:
inputting, simultaneously, black data to the plurality of pixels by applying a scan signal of a gate-on voltage to the plurality of pixels.

23. The method as claimed in claim 21, displaying the first viewpoint image data comprises:
displaying black data before the first viewpoint image data is input, and after black data is input to the plurality of pixels.
